(19) United States
(12) Patent Application Publication
(10) Pub. No.: US 2026/0072939 A1
(43) Pub. Date: Mar. 12, 2026

(54) HANDLING KEY-VALUE PAIRS IN COMPUTE NODES OF A DISTRIBUTED SYSTEM

(71) Applicant: Hewlett Packard Enterprise Development LP, Spring, TX (US)

(72) Inventors: Dylan Farrer, Bristol (GB); Thomas Mortensson, Bristol (GB)

(21) Appl. No.: 18/827,917

(22) Filed: Sep. 9, 2024

(51) Int. Cl. G06F 16/27

(52) U.S. Cl. CPC G06F 16/27

(57) ABSTRACT

In some examples, a distributed system detects misplaced key-value pairs in a first compute node of a plurality of compute nodes in the distributed system. In a maintenance interval, the distributed system initiates handling of the misplaced key-value pairs at the first compute node. A second compute node receives a request for a first key. Based on determining that a data store of the second compute node does not contain the first key, the second compute node accesses a key register to identify a compute node that contains the first key, where the key register maps keys to respective compute nodes. The second compute node accesses the identified compute node to obtain a value for the first key.

### BACKGROUND

A distributed system can include multiple compute nodes that are able to distribute workloads across the multiple compute nodes. For example, the multiple compute nodes can store respective subsets of data that can be accessed (read or written) in parallel.

### BRIEF DESCRIPTION OF THE DRAWINGS

Some implementations of the present disclosure are described with respect to the following figures.

FIG. 1 is a block diagram of a distributed system according to some examples.

FIG. 2 is a block diagram showing a get operation, according to some examples.

FIG. 3 is a block diagram showing a put operation, according to some examples.

FIG. 4 is a flow diagram of a replication process according to some examples.

FIG. 5 is a flow diagram of a node join handling process according to some examples.

FIG. 6 is a flow diagram of a delete process according to some examples.

FIG. 7 is a block diagram of a storage medium storing machine-readable instructions according to some examples.

FIG. 8 is a block diagram of a distributed system according to some examples.

FIG. 9 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In some examples, multiple compute nodes of a distributed system can include respective key-value (KV) stores that store data as KV pairs. A KV pair includes a key and a value, where the key is a unique identifier of the value, and the value is a data item (e.g., a parameter, a file, an image, a pointer to a storage location of the data item, or any other type of object). The value of the KV pair can be retrieved based on the key. Keys can be mapped to different compute nodes. If a given key is mapped to a particular compute node, then the KV pair corresponding to the given key is stored at the particular compute node. In some examples, a hash function can be applied on a key to produce a hash that is used to produce a key identifier, and the key identifier selects a compute node from the multiple compute nodes of the distributed system to which the key is mapped. The hash function applied on different keys produces different hashes that map the different keys to respective compute nodes.

An example of a distributed protocol that distributes KV pairs across a collection of compute nodes is the Chord protocol. Because Chord uses hashes to distribute KV pairs across compute nodes, the Chord protocol is also referred to as a “distributed hash table protocol.” An example of the Chord protocol is described in Ion Stoica et al., “Chord: A Scalable Peer-to-Peer Lookup Protocol for Internet Applications,” dated February 2003. Note that in the present discussion, a reference to “Chord” can refer to the Chord protocol as described in Stoica or to any other version of the Chord protocol. In further examples, other types of distributed protocols may be employed to map keys to compute nodes of a distributed system.

With a distributed protocol such as a distributed hash table protocol, various issues may be caused by new compute nodes joining a distributed system or existing compute nodes leaving the distributed system. For example, when a new compute node joins or an existing compute node exits the distributed system, some KV pairs may become misplaced. A “misplaced” KV pair is a KV pair residing on a compute node that should not be at the compute node due to a changed condition caused by joinder of a new compute node or the departure of an existing compute node. Also, when an existing compute node leaves the distributed system due to a failure or other fault of the existing compute node, KV pairs of the exited compute node may become unavailable. If a large quantity of compute nodes join or leave the distributed system, node churn can result due to spikes in workloads associated with transferring KV pairs across the compute nodes and updating routing tables in the compute nodes. The node churn can cause a slowdown in responses to requests for access of data in the distributed system.

In accordance with some implementations of the present disclosure, a lazy evaluation process performs gradual updates of a distributed system in response to transient conditions due to compute nodes joining and exiting the distributed system. The gradual updates are performed in maintenance intervals, which are intervals in which actions are taken to migrate KV pairs, remove KV pairs, update routing tables, or otherwise update compute nodes to address the transient conditions. By spacing out the maintenance intervals, spikes in workloads performed in reaction to the transient conditions can be avoided or reduced. Also, in some examples, a size parameter can be set to cap the quantity of KV pairs that can be transferred between compute nodes in any given maintenance interval, which further reduces spikes in workloads performed in reaction to the transient conditions. The lazy evaluation process may result in one or more of the following temporary unsettled states: (1) keys are temporarily misplaced at one or more compute nodes, or (2) other compute nodes have obsolete information referring to keys stored at an exited compute node. Temporary unsettled states (1) and (2) may lead to increased key lookup times, which can reduce performance of the distributed system. In some implementations of the present disclosure, to improve distributed system performance in the presence of the foregoing temporary unsettled states, a key register and a junk store can be maintained at each compute node, and replicas of KV pairs can be stored at a collection of replication compute nodes for an owner compute node.

A “key register” refers to a data structure that maps keys to compute nodes. The mapping of the key register may be a many-to-many mapping in some examples. For example, the key register can map a key to one or more compute nodes that store the key. Further, the key register can map a compute node to one or more keys stored at the compute node. Note that a compute node storing a key refers to the compute node storing the KV pair that the key is part of.

An “owner” compute node refers to a compute node that a KV pair is to be assigned based on a key identifier for the KV pair. The KV pair assigned to the owner compute node is stored in a local KV store of the owner compute node. The “local” KV store in a given compute node is the KV store containing KV pairs assigned to the given compute node based on key identifiers of the KV pairs and a node identifier of the compute node. The KV pairs assigned to the owner compute node are part of the key domain of the owner compute node.

A replica KV pair is a copy of a KV pair of an owner compute node. A “replicating” compute node is a compute node designated to store replicas of KV pairs on behalf of the owner compute node. Replica KV pairs are stored in a replica KV store of a replicating compute node.

A key identifier is derived by applying a function on a key. An example of the function is a hash function, such as a cryptographic hash function. Examples of cryptographic hash functions include Secure Hash Algorithm (SHA) functions, message digest (MD) hash functions, and so forth. In other examples, other types of functions can be applied on a key to generate a key identifier.

A node identifier, which identifies a compute node in a distributed system, is derived by applying the function (e.g., a hash function or another type of function) on node address information assigned to the compute node. The node address information of the compute node can include a network address, such as an Internet Protocol (IP) address, a Media Access Control (MAC) address, or another type of address. The node address information of the compute node can additionally include port information, such as a port number of a transport protocol (e.g., the Transmission Control Protocol (TCP), the User Datagram Protocol (UDP), or another type of transport protocol).

In some examples, a key identifier and a node identifier produced by applying the function on a key and node address information, respectively, can have the same length. For example, each of the key identifier and node identifier can be formed using m (m≥2) bits.

A junk store refers to a data structure including information specifying which keys have been deleted in compute node(s) of a distributed system. The data structure of the junk store or the key register may be in any of various forms, such as a table, a text file, a tree, or any other type of data structure.

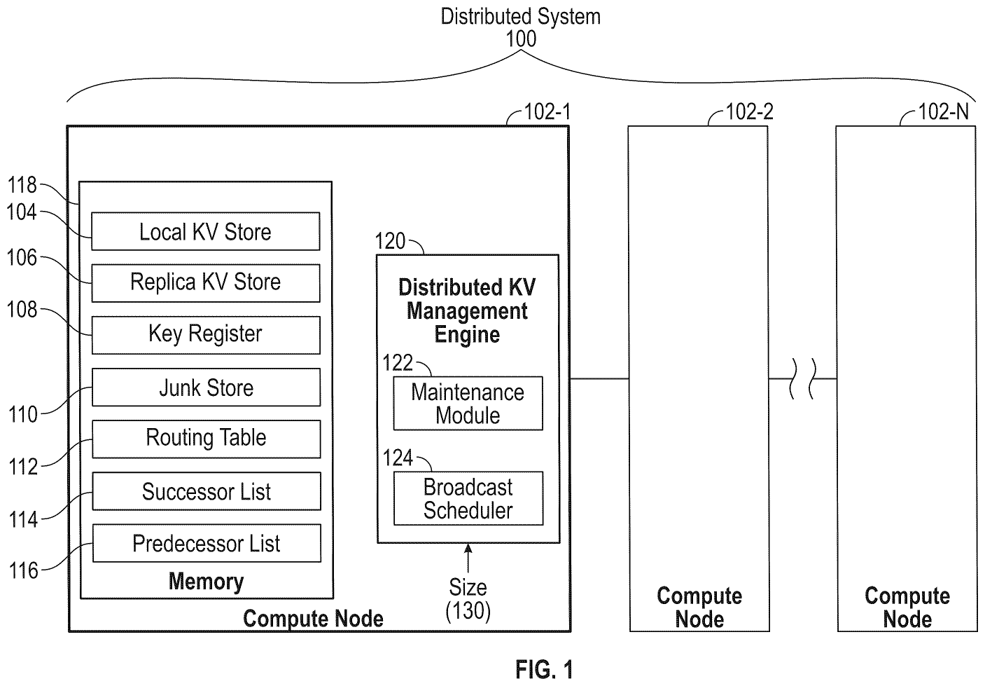

FIG. 1 is a block diagram of a distributed system 100 according to some examples. The distributed system 100 may be a distributed storage system that stores data across multiple compute nodes 102-1, 102-2, . . . , 102-N (N≥2). In other examples, the distributed system 100 can perform processing tasks, such as executing application programs or other types of programs in the compute nodes 102-1 to 102-N. The processing tasks can make use of data stored across the compute nodes 102-1 to 102-N. As further examples, the distributed system 100 can be a distributed communication system to perform communication tasks across the compute nodes 102-1 to 102-N. The communication tasks can make use of data stored across the compute nodes 102-1 to 102-N.

In some examples, the distributed system 100 includes a peer-to-peer arrangement of the compute nodes 102-1 to 102-N, in which any given compute node is able to communicate with two peer compute nodes (including a predecessor compute node and a successor compute node as discussed below). In the peer-to-peer arrangement, a message from the given compute node are sent to a peer compute node, which can forward the message to another compute node. In other examples, the distributed system 100 can include a parallel arrangement of the compute nodes 102-1 to 102-N in which a given compute node can communicate directly over a network with any other compute node of the distributed system 100.

A “compute node” can refer to a physical computer (or multiple physical computers). Alternatively, a “compute node” can refer to a virtual compute node (or multiple virtual compute nodes). A virtual compute node can refer to a virtual machine (VM), a container, or any other type of virtual entity that can execute computational tasks.

In any of the various example distributed systems, KV stores can be stored in respective compute nodes of the distributed system. Each KV store contains KV pairs assigned to the compute node including the KV store. The assignment of a KV pair to a compute node is based on the key identifier of the key of the KV pair and the node identifier of the compute node.

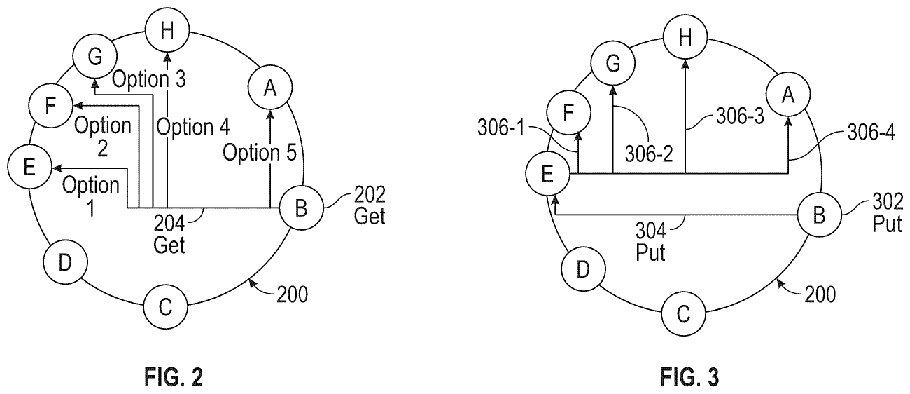

Keys are assigned to compute nodes by using an identifier ring, where different points on the identifier ring correspond to different identifiers, which can be key identifiers and node identifiers. In some examples, the identifier ring can be according to the Chord protocol. Identifier rings are shown in FIG. 2 and FIG. 3 (discussed further below). Assuming that key identifiers and node identifiers are each m bits in length, then the identifier ring has 2^{m} points corresponding to the 2^{m} possible identifiers (key identifiers or node identifiers).

FIG. 1 shows components inside the compute node 102-1. The other compute nodes 102-2 to 102-N can have a similar arrangement of components.

The compute node 102-1 includes a local KV store 104 that stores KV pairs assigned to the compute node 102-1. The compute node 102-1 is the owner of the KV pairs stored in the local KV store 104.

The compute node 102-1 also includes a replica KV store 106. The replica KV store 106 stores copies of KV pairs owned by one or more other compute nodes. In other examples, multiple replica KV stores 106 can be maintained in the compute node 102-1, where one replica KV store 106 corresponds to a respective owner compute node. In the latter examples, a first replica KV store 106 stores copies of KV pairs owned by a first compute node, a second replica KV store 106 stores copies of KV pairs owned by a second compute node, and so forth. In the ensuing discussion, it is assumed that there is one replica KV store 106 to store replica KV pairs for potentially multiple owner compute nodes.

The compute node 102-1 also includes a key register 108 that maps keys to compute nodes. The key register 108 can map each key to a set of compute nodes, where a “set” can refer to a single item or multiple items (e.g., a single compute node or multiple compute nodes). Further, the key register 108 can map each compute node to a set of keys. Mapping a key to a compute node can refer to mapping the key identifier of the key to the node identifier of the compute node. Alternatively, mapping the key to the compute node can refer to mapping the key to the node address information (e.g., a combination of an IP address and port number) of the compute node.

The compute node 102-1 also includes a junk store 110 that lists keys that have been deleted from the compute node 102-1 and/or at any other compute node. The junk store 110 can include key identifiers of the keys that have been deleted, or alternatively, the junk store can include the actual deleted keys themselves.

The compute node 102-1 also includes a routing table 112. In examples where Chord is used, the routing table 112 is in the form of a finger table. The routing table 112 contains information that the compute node 102-1 can use to determine at which compute node a key is stored (assuming the key is not in the local KV store 104 or the replica KV store 106 of the compute node 102-1). An explanation of a finger table is provided further below.

The compute node 102-1 includes a successor list 114, which identifies successor compute nodes of the compute node 102-1. The successor compute nodes of the compute node 102-1 include the immediate successor compute node (which is the compute node that immediately follows the compute node 102-1 on the identifier ring), and one or more secondary successor compute nodes. A secondary successor compute node follows the immediate successor compute node or another secondary successor compute node on the identifier ring. Note that there is no other compute node between the compute node 102-1 and the immediate successor compute node. Note that the term “successor list” can refer to either (1) a single successor list that identifies both the immediate successor compute node and one or more secondary successor compute nodes, or (2) two separate successor lists including an immediate successor list that identifies the immediate successor compute node and a secondary successor list that identifies one or more secondary successor compute nodes.

The compute node 102-1 also includes a predecessor list 116 that identifies a predecessor compute node of the compute node 102-1, which is the compute node that is immediately before the compute node 102-1 on the identifier ring. Each of the successor list 114 and the predecessor list 116 can be implemented using an array or any other type of data structure containing information to identify compute nodes.

The various structures 104, 106, 108, 110, 112, 114, and 116 can be stored in a memory 118, which can be implemented using one or more memory devices. The memory 118 may be a persistent memory implemented with one or more persistent memory devices.

The compute node 102-1 further includes a distributed KV management engine 120 that manages the distributed storage of KV pairs across the compute nodes 102-1 to 102-N of the distributed system 100. Note that new compute nodes may join the distributed system 100, and existing compute nodes may leave the distributed system 100. In either case, a temporary unsettled state (as discussed further above) may arise that is addressed by the distributed KV management engine 120.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

The distributed KV management engine 120 receives or is configured with a size parameter 130 that is set to cap the quantity of KV pairs that can be transferred between compute nodes in any given maintenance interval.

In some examples, the distributed KV management engine 120 includes a maintenance module 122 and a broadcast scheduler 124. The maintenance module 122 performs maintenance tasks to resolve temporary unsettled states. The maintenance tasks may be performed on a periodic basis in which the maintenance tasks are performed during maintenance intervals that are started periodically (after a specified time has expired) or that are started in response to other triggers, such as a trigger due to detection of an error in the distributed system 100, a trigger due to detection of a reduced performance of the distributed system 100, a trigger due to a request submitted by an entity (e.g., a human, a program, or a machine), or any other event.

The broadcast scheduler 124 schedules the transmission of broadcast messages to other compute nodes to notify the other compute nodes of certain events, such as an event relating to writing a KV pair to the local KV store 104 or the replica KV store 106 of the compute node 102-1, or an event relating to deleting a KV pair from the compute node 102-1. A “broadcast” message is a message intended to be received by multiple compute nodes in the distributed system 100. Broadcast messages may be sent periodically or in response to other triggers, such as any of the triggers noted above.

Each of the maintenance module 122 and the broadcast scheduler 124 can be implemented with a portion of the hardware processing circuitry of the distributed KV management engine 120, or as machine-readable instructions executed by a processing resource of the distributed KV management engine 120.

FIG. 2 is a block diagram of an example identifier ring 200. Points on the identifier ring 200 represent respective different identifiers (key identifiers or node identifiers). If m-bit identifiers are used, then there are 2^{m} points representing 2^{m} identifiers (ranging from 0 to 2^{m}-1) on the identifier ring 200. In the example of FIG. 2, eight compute nodes (A, B, C, D, E, F, G, and H) are depicted at respective positions on the identifier ring 200. The position of a compute node on the identifier ring 200 is based on the node identifier of the compute node. In the example of FIG. 2, it is assumed that the distributed system 100 of FIG. 1 has eight compute nodes. In other examples, the distributed system 100 can include a different quantity of compute nodes.

In some examples, to obtain a node identifier of a compute node, a hash function is applied to node address information (e.g., a combination of an IP address and port number) of the compute node, which produces a node hash value. An arithmetic modulo 2^{m} operation is performed on the node hash value to obtain an m-bit node identifier of the compute node, where the m-bit node identifier is a position on the identifier ring 200. A modulo 2^{m} arithmetic operation refers to finding the remainder of the hash value. To obtain a key identifier of a key, the hash function is applied to the key that produces a key hash value. The arithmetic modulo 2^{m} operation is performed on the key hash value to obtain an m-bit key identifier of the key, where the m-bit key identifier is a position on the identifier ring 200.

In the example of FIG. 2, compute node A is an immediate successor compute node of compute node H, and compute node B is a secondary successor compute node of compute node H. Assuming that there are four successor compute nodes associated with any compute node, then compute nodes A, B, C, and D are successor compute nodes of compute node H (B, C, and D are secondary successor compute nodes of H). The immediate successor compute node of compute A is compute node B, and the secondary successor compute nodes of compute node A are compute nodes C, D, and E. The immediate successor compute node of compute node G is compute node H, and the secondary successor compute nodes of compute node G are compute notes A, B, and C.

Key k is assigned to a compute node as follows. Key k is assigned to the first compute node whose node identifier is equal to or follows the key identifier of key k on the identifier ring 200. Such a compute node is referred to as a successor compute node of key k. For example, if compute node H has node identifier 0, compute node A has node identifier 4, and compute node B has node identifier 9, then if key k has a key identifier 3, key k is assigned to compute node A, which is the first compute node whose node identifier is equal to or follows the key identifier of key k on the identifier ring 200.

The term “successor” can refer to either a successor compute node of a given compute node, or a successor compute node of a key.

In examples where the routing table 112 of FIG. 1 is a finger table, the i-th entry in the finger table at compute node n (n=1 to N) contains the node identifier of the first compute node s that succeeds n by at least 2ⁱ⁻¹ on the identifier ring 200, i.e., s=successor(n+2ⁱ⁻¹), where 1≤i≤m.

Node s is referred to as the i-th finger of node n. The finger table contains up to m entries, where m is the number of bits in the key identifier or node identifier. The first entry of the finger table is the compute node's immediate successor compute node.

In some examples, R (R≥1) replica KV stores are maintained at R respective replicating compute nodes for each local KV store in an owner compute node. The presence of the replica KV stores provides resilience to compute node failures, allows for recovery of KV pairs, and allows for the lookup of a given key to be satisfied from any of several compute nodes that store local and replica KV stores containing the given key.

### Get Operation

FIG. 2 shows an example of how a Get request 202 from a requester (e.g., a client device or a program) is handled. The Get request 202 requests the value for key k. More generally, a Get request can request the value(s) of a set of keys (a single key or multiple keys). In the example of FIG. 2, the Get request 202 is received by compute node B.

The receiving compute node (compute node B in this example) invokes a Get routine that checks whether key k requested by the Get request 202 is in the local KV store 104 or the replica KV store 106 of compute node B. A “routine” (also referred to as a “method”) can refer to machine-readable instructions that when invoked perform specified tasks. If key k is in the local or replica KV store, the Get routine retrieves the value for key k from the local KV store 104 or the replica KV store 106, and compute node B returns the value to the requester. At this point, the get operation completes. The retrieval of the value from the local KV store 104 or the replica KV store 106 of compute node B can be performed in constant time.

However, FIG. 2 assumes an example in which key k is not in the local KV store 104 or the replica KV store 106 of compute node B. In this latter case, the Get routine checks the key register 108 of compute node B to determine if key k is listed in the key register 108. Key k may have been added to the key register 108 of compute node B if another compute node (X) sent a notification to compute node B specifying that compute node X has put key k in the local KV store 104 or the replica KV store 106 of compute node X. The key register 108 may return information of one or more compute nodes (e.g., the owner compute node and any replicating compute nodes) mapped to key k. The returned information can include node identification information of each respective compute node mapped to key k in the key register 108. The returned node identification information can be either the node address information (e.g., IP address and port number) or the node identifier of the respective compute node.

If information of multiple compute nodes is returned, the Get routine can select one of the multiple compute nodes to query for key k. The selection of a compute node to query can be based on a random selection of the compute node from among the multiple compute nodes, or based on another criterion, such as the compute node closest to compute node B on the identifier ring 200. In the example of FIG. 2, assuming key k is available at each of compute nodes E, F, G, H, and A, compute node B has the option of selecting any of these compute nodes (any of options 1, 2, 3, 4, an 5) to which the Get request 202 is forwarded (at 204) from compute node B.

In some examples, he upper limit on the number of compute nodes contacted based on use of the key register 108 is 0(log(N)), where N is the number of compute nodes in the distributed system 100. However, the access time is constant if the requested key is present in receiving compute node's key register, and the compute node identified by the key register is stable (e.g., KV pairs, including local KV pairs or replica KV pairs that should be at the identified compute node are at the identified compute node).

Note that the information of the compute node(s) mapped to the key k can be retrieved from the key register 108 in constant time. The compute node to which the Get request 202 is forwarded can return the value for key k to compute node B, at which point compute node B returns the value to the requester. However, if the compute node to which the Get request 202 does not return the value for key k (e.g., because that compute node is no longer reachable or no longer has the value for key k), the Get routine can select the next compute node (if multiple compute nodes are listed in the key register 108) to forward the Get request 202. Compute node B can iterate through the multiple compute nodes until one of the compute nodes returns the value for key k.

If the key register 108 does not contain any information for key k, then the Get routine in compute node B can initiate a lookup procedure to find the owner compute node, e.g., the first successor compute node that follows the key identifier of key k on the identifier ring 200. For example, the Get routine can call a Find Successor routine. The Find Successor routine can use the routing table 112 of compute node B. In some examples, the lookup procedure can be according to the Chord protocol, in which case the routing table 112 includes a finger table. The Find Successor routine accesses the finger table in compute node B to determine if the entries of the finger table contain a node identifier that is equal to or follows the key identifier of key k on the identifier ring 200. If present, this node identifier identifies the owner compute node of key k. In this case, compute node B forwards the Get request 202 to the owner compute node. In some examples, the number of compute nodes that are contacted by the Find Successor routine is 0(log(N)), where N is the number of compute nodes in the distributed system 100.

However, the finger table in compute node B may not contain the node identifier that is equal to or follows the key identifier of key k on the identifier ring 200. In this case, the Find Successor routine finds the largest node identifier (also referred to as the largest finger) in the finger table of compute node B that precedes the key identifier of key k. This largest node identifier identifies compute node Y. Compute node B forwards the Get request 202 to compute node Y, which then initiates a lookup procedure to find the owner compute node of key k. If the finger table of compute node Y also does not contain the node identifier that is equal to or follows the key identifier of key k on the identifier ring 200, the compute node Y can forward the Get request 202 to another compute node. The above process iterates through a chain of compute nodes until a compute node that receives the Get request 202 is able to find, in its finger table, the node identifier that is equal to or follows the key identifier of key k on the identifier ring 200. At this point, the compute node forwards the Get request 202 to the owner compute node, which returns the value for key k. The returned value is transferred through the chain of compute nodes that participated in forwarding the Get request 202 to the owner compute node. The returned value is ultimately received at compute node B, which provides the returned value to the requester.

### Put Operation

FIG. 3 shows an example of how a Put request 302 from a requester is handled. The Put request 302 requests the writing of a KV pair (including key k). More generally, a Put request can request the writing of a set of KV pairs (a single KV pair or multiple KV pairs). In the example of FIG. 2, the Put request 302 is received by compute node B.

In response to the Put request 302, compute node B invokes a Put routine. The Put routine at compute node B checks whether key k is in the junk store 110 of compute node B. If so, the Put routine exits without writing the KV pair. Key k in the junk store 110 means that the KV pair including key k has been deleted (either at compute node B or at another compute node). Note that a key is kept in the junk store 110 for a specified junk store retention period (which can be tuned by a system administrator or another entity). Each key in the junk store 110 is associated with a timestamp indicating when the key was deleted. Once the specified junk store retention period has passed from the time of deletion of a key, the key is removed from the junk store 110. Listing a key in the junk store 110 prevents the writing (putting) of the same key into the distributed system 100 until after the specified junk store retention period has expired.

It is also possible that the KV pair of the Put request 304 may already be stored in the local KV store 104 of compute node B. In this case, the Put request 304 is also ignored and the KV pair is not written again.

Assuming key k is not in the junk store 110, the Put routine identifies the owner compute node of key k using the routing table 112. In examples where the routing table 112 is a finger table according to the Chord protocol, the Put routine identifies the successor compute node of key k using the finger table by invoking the Find Successor routine. If the identified owner compute node is the compute node (B in the example of FIG. 3) that received the Put request 302, then compute node B writes the KV pair into the local KV store 104 of compute node B. Compute node B then replicates the KV pair to R replicating compute nodes (identified in the successor list 114 of compute node B). The R replicating compute nodes for an owner compute node are referred to as a group of replicating compute nodes associated with the owner compute node.

In the example of FIG. 3, it is assumed that the owner compute node identified by the Put routine is compute node E. In this case, compute node B forwards (at 304) the Put request 302 to compute node E, which triggers a Put routine at compute node E. The Put routine at compute node E determines whether (1) key k is in the junk store 110 of compute node E, and (2) the KV pair including key k is already contained in the local KV store 104 of compute E. If either (1) or (2) is true, compute node E ignores the Put request 304. If (1) and (2) are both false, the Put routine at compute node E writes the KV pair into the local KV store 104 of compute node E. In addition to writing the KV pair to the local KV store 104, compute node E also replicates (at 306-1, 306-2, 306-3, and 306-4) the KV pair to R replicating compute nodes (if R=4, then the replicating compute nodes are F, G, H, and A, which are identified in the successor list 114 of compute node E).

After a given compute node (B or E) stores the KV pair in response to the Put request 304, the broadcast scheduler 124 in the given compute node can send a broadcast message in the next maintenance interval to notify other compute nodes that the KV pair has been stored at the given compute node. Each of the other compute nodes can update its respective key register 108 to map key k to the given compute node.

### Replication

As noted above, R replica KV stores are maintained for each local KV store in a compute node. In some examples, R can be set based on the ring space of the identifier ring 200. For example, if the ring space is 2^{m} assuming that m-bit identifiers are used, then in some examples R can be set to a maximum of m+1, which means for any compute node n including a given KV pair stored in a local KV store, R replica KV pairs of the given KV pair can be maintained at the immediate successor compute node and at a maximum of up to m secondary successor compute nodes. In other examples, R replica KV pairs of the given KV pair in compute node n can be maintained at the immediate successor compute node and at a maximum of up to m−1 (or more generally, m-c, where c is an integer less than m) secondary successor compute nodes. In some examples, the number (R) of replica KV pairs scales with the ring space of the distributed system 100 (in other words, as the ring space increases, the number of replica KV pairs is also increased, and vice versa).

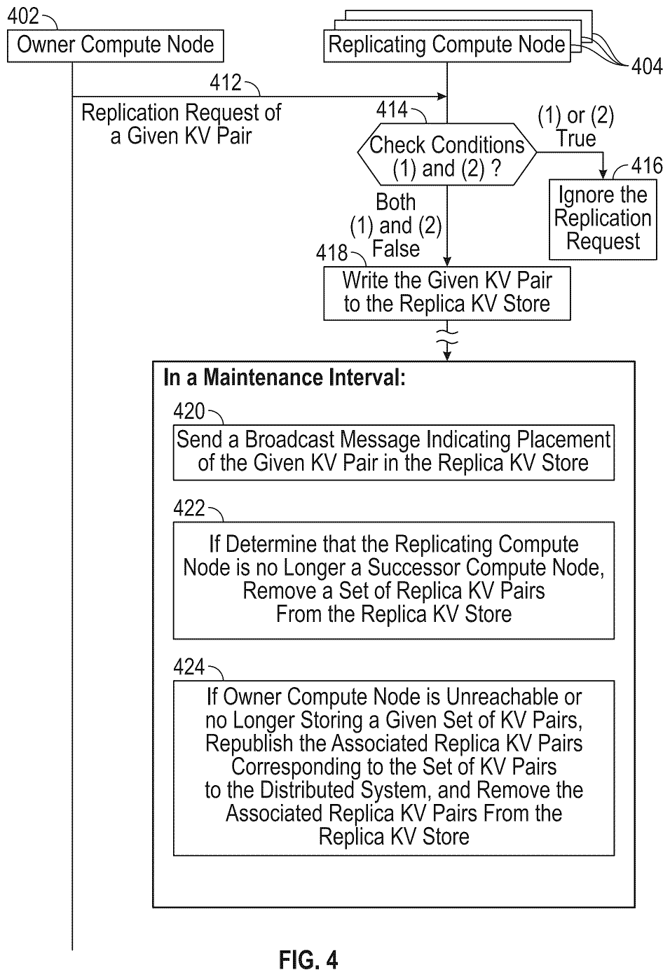

FIG. 4 shows a replication process. Although FIG. 4 shows a sequence of tasks, note that in other examples, the tasks may be performed in a different order, some of the tasks may be omitted, and other tasks may be added.

To ensure replicas are available in the distributed system 100, the maintenance module 122 in the distributed KV management engine 120 of an owner compute node 402 can periodically (or in response to another trigger) request (at 412), in a maintenance interval, the R successor compute nodes 404 (identified in the successor list 114) of the owner compute node to replicate a given KV pair if any successor compute node is not already doing so.

The maintenance module 122 in the owner compute node 402 can request replication of the given KV pair by calling a Replicate routine at each of the R replicating compute nodes 404. The Replicate routine at a replicating compute node 404 checks (at 414) if (1) the replicating compute node 404 is already storing a replica of the given KV pair, or (2) if the junk store 110 in the replicating compute node 404 contains the key of the given KV pair (which means that the given KV pair has been deleted). If the Replicate routine determines (at 414) that either condition (1) or (2) is true, then the Replicate routine ignores (at 416) the request to replicate the given KV pair.

If the Replicate routine determines (at 414) that both conditions (1) and (2) are false, then the Replicate routine writes (at 418) the given KV pair to the replica KV store 106 of the replicating compute node 404. In some examples, in addition to writing the given KV pair to the replica KV store 106, node identification information of the owner compute node 402 can be added as metadata to the replica KV store 106 to indicate which compute node is the owner of the given KV pair in the replica KV store 106. The node identification information of the owner compute node 402 can be either the node address information (e.g., IP address and port number) or the node identifier of the owner compute node 402.

In the next maintenance interval, the broadcast scheduler 124 in the replicating compute node 404 can send (at 420) a broadcast message (e.g., a Key Notify message as discussed further below) indicating that the replicating compute node 404 has placed the given KV pair in the replicating compute node 404. The other compute nodes receiving the broadcast message can update their respective key registers 108 to map the key of the given KV pair to the replicating compute node 404.

Additionally, if the replicating compute node 404 determines, in a maintenance interval, that the replicating compute node 404 is no longer a successor compute node of the owner compute node 402 (such as due to a new compute node joining the distributed system 100), the maintenance module 122 in the replicating compute node 404 can remove (at 422) replica KV pairs associated with the owner compute node 402 (e.g., by deleting the associated replica KV pairs).

If the replicating compute node 404 detects, in a maintenance interval, that (a) the owner compute node 402 is unreachable (e.g., due to the owner compute node 402 exiting the distributed system 100), or (b) the owner compute node 402 is no longer storing a given set of KV pairs, the replicating compute node republishes (at 424) the associated replica KV pairs corresponding to the set of KV pairs into the distributed system 100, and further, the replicating compute node 404 removes the associated replica KV pairs from the replica KV store 106 of the replicating compute node 404. Republishing a KV pair refers to putting (writing) the KV pair (having key k) to the first compute node whose node identifier is equal to or follows the key identifier of key k on the identifier ring 200.

Note that tasks 412, 414, 416, 418, 420, 422, and 424 may be performed in one or more maintenance intervals.

### Caching

The key register 108 and the junk store 110 of a compute node are considered caching data structures for keys to increase key visibility and to improve the performance of lookup operations. Finding a key in the key register 108 allows a compute node to quickly determine which other computer node stores the key. Finding a key in the junk store 110 allows a compute node to quickly determine that the KV pair including the key has been deleted.

The key register 108 and the junk store 110 of a compute node are updated based on broadcast messages sent by the broadcast schedulers 124 of other compute nodes in maintenance intervals. If broadcast messages are sent periodically, the periodicity at which the broadcast messages are tunable, such as by an administrator or another entity.

Broadcast messages (e.g., Key Notify messages) sent by a compute node include the following: a Key Notify message sent in response to storing a set of KV pairs in the local KV store 104, a Key Notify message sent in response to storing a set of KV pairs in the replica KV store 106, and a Key Notify message sent in response to adding key(s) of a set of KV pairs to the junk store 110 due to deletion of the set of KV pairs. In other examples, a broadcast message, e.g., a Key Notify message, may include multiple information elements: (1) a first information element identifying a set of KV pairs written to the local KV store 104, (2) a second information element identifying a set of KV pairs written to the replica KV store 106, and (3) a third information element identifying a set of keys (and time of deletion of each key) added to the junk store 110.

A recipient compute node that receives a Key Notify message updates the key register 108 or the junk store 110 according to the Key Notify message. Moreover, the recipient compute node forwards the received Key Notify message to the successor compute node of the recipient compute node.

Including deleted keys in Key Notify messages ensures that KV pair delete operations are recognized throughout the entire distributed system 100. Note that even compute nodes that do not store or replicate a recently deleted KV pair will be aware of the deletion.

### Compute Node Join

A compute node can join the distributed system 100. The compute node can be a new compute node not previously part of the distributed system 100. Alternatively, the compute node may have previously exited the distributed system 100 and has rejoined.

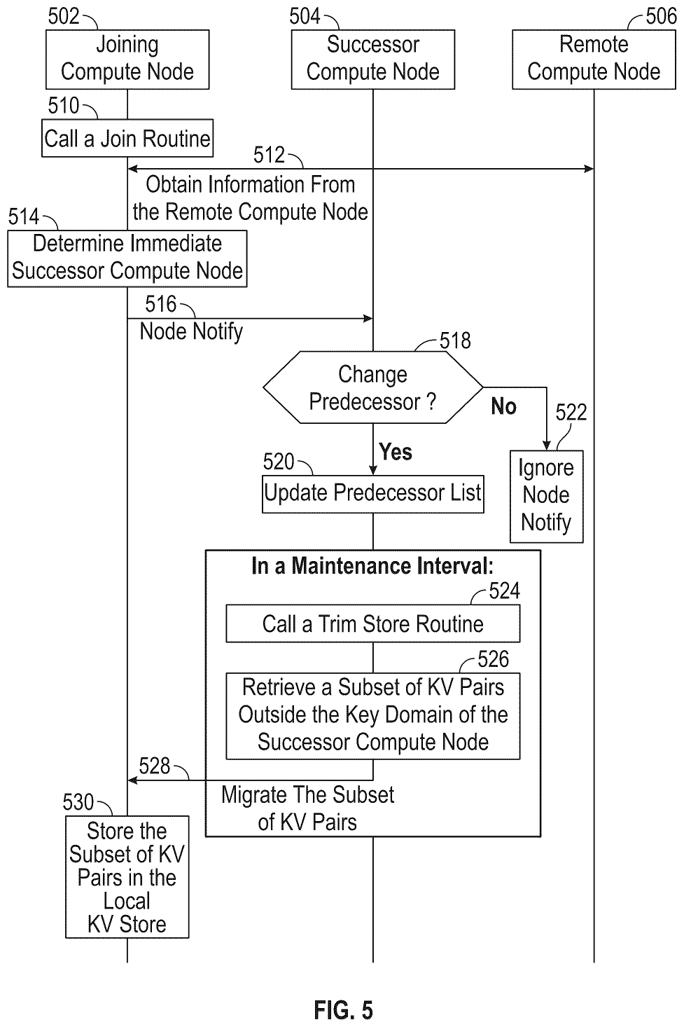

FIG. 5 shows a node join handling process. Although FIG. 5 shows a sequence of tasks, note that in other examples, the tasks may be performed in a different order, some of the tasks may be omitted, and other tasks may be added.

When a compute node 502 joins the distributed system 100, the distributed KV management engine 120 of the joining compute node 502 calls (at 510) a Join routine. The joining compute node 502 may be configured with node address information of at least one other compute node (e.g., a remote compute node 506) in the distributed system 100. The Join routine can contact the remote compute node 506 to obtain (at 512) information of various structures (e.g., the finger table, the successor list 114, and the predecessor list 116) of the remote compute node 506. Using the obtained information, the Join routine can determine (at 514) the immediate successor compute node (e.g., a successor compute node 504 in FIG. 5) of the joining compute node 502. The joining compute node 502 sets its immediate successor as the compute node the joining compute node 502 initially communicated with to join the distributed system 100. As the joining compute node 502 fills out its routing information, the joining compute node 502 can determine if a different successor should be selected and will update the information in the joining compute node 502 accordingly.

The distributed KV management engine 120 of the joining compute node 502 can send (at 516) a Node Notify message to the successor compute node 504. The Node Notify message indicates to the successor compute node 504 that the joining compute node 502 has assigned the successor compute node 504 as the joining compute node's successor.

In response to the Node Notify message, the successor compute node 504 determines (at 518) whether the successor compute node 504 should change its predecessor to the joining compute node 502. If so, the successor compute node 504 updates (at 520) the predecessor list 116 to refer to the joining compute node 502. On the other hand, if the successor compute node 504 determines (at 518) that the successor compute node 504 should not change its predecessor to the joining compute node 502 (which may be the case if the joining compute node 502 incorrectly identified its immediate successor compute node), then the successor compute node 504 ignores (at 522) the Node Notify message.

Assuming that the successor compute node 504 has updated its predecessor to the joining compute node 502, this means that a subset of the KV pairs stored in the local KV store 104 of the successor compute node 504 is misplaced (i.e., the successor compute node 504 is no longer the owner compute node of the subset of the KV pairs due to the addition of the joining compute node 502 to the distributed system 100).

In a next maintenance interval, the maintenance module 122 of the successor compute node 504 calls (at 524) a Trim Store routine to update the local KV store 104 of the successor compute node 504. If the successor compute node 504 has a non-null predecessor (i.e., the predecessor list 116 identifies a predecessor compute node that is reachable), the Trim Store routine retrieves (at 526) the subset of KV pairs in the local KV store 104 that are outside of the key domain of the successor compute node 504. This subset of KV pairs include key identifiers that are not between the node identifier of the joining compute node 502 and the node identifier of the successor compute node 504. In other words, due to the addition of the joining compute node 502, the node identifier of the joining compute node 502 is equal to or follows the key identifiers of keys of the subset of KV pairs on the identifier ring 200.

The successor compute node 504 migrates (at 528) the subset of KV pairs to the joining compute node 502, which stores (at 530) the subset of KV pairs in the local KV store 104 of the joining compute node 502. The migration of the subset of KV pairs is performed by republishing the subset of KV pairs into the distributed system 100, which results in the subset of KV pairs being placed at the joining compute node 502.

In some examples, to reduce spikes in workload associated with migrating KV pairs between compute nodes, the size parameter 130 can be set to cap the quantity of KV pairs that can be transferred within any maintenance interval. In such examples, the quantity of KV pairs in the retrieved subset of KV pairs that is to be migrated is capped by the size parameter 130. For example, if there are 75 KV pairs that are to be migrated to the joining compute node 502, but the size parameter 130 is set at 25 (indicating that the maximum quantity of KV pairs that can be transferred is 25), then the migration of the 75 KV pairs would take at least three maintenance intervals to complete. Other events in the distributed system 100 may cause more misplaced KV pairs, which may affect the number of maintenance intervals involved to transfer all misplaced KV pairs.

The Node Notify message received by the compute node 504 from the joining compute node 502 can be forwarded for receipt by other compute nodes in the distributed system 100. As a result, the other compute nodes can update their respective routing tables 112 (e.g., finger tables).

### Compute Node Exit

A compute node may exit the distributed system 100 for various reasons, such as due to a fault or failure of the compute node, an administrator taking down the compute node for maintenance, or for any other reason. Other compute nodes in the distributed system 100 have saved information (e.g., in the key register 108, the routing table 112, the successor list 114, and the predecessor list 116) relating to the exited compute node that may have to be removed or updated.

To avoid workload spikes, the saved information of the exited compute node is removed or updated gradually (as part of the lazy evaluation process). Examples of routines that can be invoked by the maintenance module 122 in a compute node (other than the exited compute node) to remove or update saved information relating to the exited compute node include the following: a Trim Register routine, a Fix Fingers routine, a Stabilize routine, and a Check Predecessor routine.

In some examples, as a result of a compute node joining or a compute node exiting, O(RK/N) KV pairs are transferred (either as a result of publishing of KV pairs for an exited compute node, or as a result of migrating KV pairs to the joining compute node). N, K, and R are the total compute node count, total key count, and the replication limit, respectively. These KV pairs are transferred in respective maintenance intervals.

For N compute nodes, K keys, and R replicating compute nodes, each compute node is responsible for O(RK/N)) keys. Also, a compute node stores at most RK keys in the key register 108.

### Update Key Register

The maintenance module 122 of a compute node (“compute node p” where p represents a compute node other than the exited compute node) can call the Trim Register routine in a maintenance interval (e.g., periodically or in response to another trigger) to check if any compute node listed in the key register 108 of compute node p is unreachable. In an example, the Trim Register routine can retrieve information of a subset of compute nodes listed in the key register 108. The number of compute nodes in this subset can be capped by the potential size of the identifier ring 200 (e.g., if an identifier is implemented with 8 bits, then the potential size is 2⁸ or 256).

The Trim Register routine iterates through each compute node n of the subset of compute nodes to determine whether compute node n is unreachable. If compute node n is unreachable, the Trim Register routine removes mappings of any keys to compute node n from the key register 108.

However, if compute node n is reachable, the Trim Register routine obtains a subset of keys (with a quantity of keys capped by the size parameter 130) mapped to compute node n by the key register 108. The Trim Register routine iterates through each key k of the subset of keys and calls an Is_Storing_Key routine at compute node n. The Is_Storing_Key routine at compute node n can provide a response indicating whether key k is stored at compute node n. If so, the mapping of key k to compute node n is kept in the key register 108. However, if key k is no longer stored at compute node n, the Trim Register routine removes the mapping of key k to compute node n from the key register 108.

### Update Routing Table

In examples where the routing table 112 is a finger table, the maintenance module 122 of compute node p (a compute node other than the exited compute node)) can call the Fix Fingers routine in a maintenance interval. The Fix Fingers routine in compute node p iterates through the finger table of compute node p to determine whether the i-th entry of the finger table at compute node p contains the node identifier of the first compute node s that succeeds p by at least 2ⁱ⁻¹ on the identifier ring 200. If not, the i-th entry of the finger table is updated with the node identifier of the first compute node s that succeeds p by at least 2ⁱ⁻¹ on the identifier ring 200.

### Update Successor List

The maintenance module 122 of compute node p (a compute node other than the exited compute node) can call the Stabilize routine in a maintenance interval. The Stabilize routine in compute node p performs a number of checks. First, if the immediate successor compute node of compute node p is unreachable, the Stabilize routine attempts to reassign a secondary successor compute node from the successor list 114 as the immediate successor compute node, and updates the successor list 114 accordingly.

Second, the Stabilize routine in compute node p queries compute node n (indicated by the successor list 114 as being compute node p's immediate successor compute node) for the predecessor of compute node n. The compute node n checks its predecessor list 116 and returns node identification information of the predecessor compute node listed in the predecessor list 116 of compute node n. If the predecessor compute node identified by compute node n is not compute node p, then the Stabilize routine updates the successor list 114 to indicate that the predecessor compute node identified by compute node n is to be set as the immediate compute node of compute node p.

### Update Predecessor List

The maintenance module 122 of compute node p (a compute node other than the exited compute node) can call a Check Predecessor routine in a maintenance interval. The Check Predecessor routine checks whether the predecessor compute node identified by the predecessor list 116 in compute node p is reachable. If so, no change is made to the predecessor list 116. However, if the predecessor compute node is unreachable, the Check Predecessor routine can assign another compute node as the predecessor compute node and update the predecessor list 116.

### Update Replication

In further examples, an exited compute node may be an owner compute node associated with a group of replicating compute nodes. In this case, each replicating compute node can take action to address the exited owner compute node.

In another example, an exited compute node may have been a replicating compute node for an owner compute node, in which case the owner compute node would have to update its group of replicating compute nodes by asking another compute node to replicate KV pairs in the local KV store 104 of the owner compute node.

Note that an exited compute node is likely to be an owner compute node for some KV pairs, and a replicating compute node for other KV pairs.

The following example routines can be called to address the above cases where the exited compute node is a replicating compute node or an owner compute node that has requested other compute nodes perform replications: a Trim Replications routine, a Maintain Replicators routine, and a Maintain Replications routine. In the ensuing discussion, compute node o is an owner compute node that has requested other compute nodes (replicating compute nodes) to replicate KV pairs of the owner compute node. A replicating compute node is referred to as compute node r.

The maintenance module 122 of compute node r (a replicating compute node for owner compute node o) can call the Trim Replications routine in a maintenance interval. In this example, owner compute node o may be the exited compute node. The Trim Replications routine in compute node r can access the replica KV store 106 in compute node r to retrieve node identification information of a compute node (e.g., compute node o) that requested a replica KV pair in the replica KV store 106.

The Trim Replications routine attempts to contact compute node o. If compute node o is unreachable, all replica KV pairs (referred to as “associated replica KV pairs”) associated with compute node o in the replica KV store 106 of compute node r are retrieved and republished into the distributed system 100. The republishing of the associated replica KV pairs places (in put operations) the associated replica KV pairs in one or more assigned compute nodes. In some examples, to reduce spikes in workload, a quantity of associated KV pairs that is republished in a maintenance interval is capped by the size parameter 130.

The associated replica KV pairs are also deleted from the replica KV store 106 in compute node r, since the compute node o is no longer reachable and compute node r should not replicate the associated KV pairs for compute node o anymore.

If compute node o is reachable, the Trim Replications routine in compute node r iterates through each key k of the associated replica KV pairs. If compute node o is no longer the owner compute node of key k (i.e., key k is not stored in the local KV store 104 of compute node o), then the Trim Replications routine in compute node r republishes the KV pair containing key k, and deletes the KV pair containing key k from the replica KV store 106 of compute node r.

The maintenance module 122 of compute node r can call the Maintain Replications routine in a maintenance interval. The Maintain Replications routine in compute node r can access the replica KV store 106 in compute node r to retrieve node identification information of a compute node (e.g., compute node o) which may have asked compute node r to replicate KV pairs locally stored at compute node o.

The Maintain Replications routine in compute node r queries compute node o to determine whether compute node r is still in compute node o's successor list 114. Note that a new compute node may have joined the distributed system 100, and node identifier of the new compute node is between compute node o and compute node r on the identifier ring 200. Compute node r may no longer be part of the R replicating compute nodes for compute node o due to the joinder of the new compute node.

If the compute node r is not in compute node o's successor list 114, the Maintain Replications routine retrieves associated replica KV pairs associated with compute node o in the replica KV store 106 of compute node r and republishes the associated replica KV pairs into the distributed system 100. The quantity of associated replica KV pairs republished is capped by the size parameter 130. Moreover, the Maintain Replications routine removes the associated replica KV pairs from the replica KV store 106 of compute node r.

If the compute node r is still in compute node o's successor list 114, the Maintain Replications routine iterates over the associated replica KV pairs to determine if any key k of the associated replica KV pairs is no longer assigned to compute node o. The Maintain Replications routine removes the replica KV pair containing any such key k from the replica KV store 106 of compute node r and republishes the replica KV pair.

The maintenance module 122 of compute node o can call the Maintain Replicators routine in a maintenance interval. The Maintain Replicators routine in compute node o retrieves KV pairs from the local KV store 104 of compute node o. For each given KV pair of the retrieved KV pairs, the Maintain Replicators routine determines, based on accessing the key register 108, a quantity of compute nodes replicating the given KV pair. The key register 108 maps keys to compute nodes, so that the key register 108 would provide an indication to the Maintain Replicators routine how many other compute nodes (aside from compute node o) are storing the given KV pair.

If the quantity of compute nodes replicating the given KV pair is less than R (the number of replicating compute nodes that should be associated with compute node o), the Maintain Replicators routine adds one or more compute nodes to the successor list 114 to reach R compute nodes. The Maintain Replicators routine then asks each compute node in the successor list 114 to replicate the given KV pair.

In some examples, replicating compute nodes are not aware of one another. Therefore, the owner compute node (compute node o) is responsible checking that a sufficient number of compute nodes are replicating KV pairs of the owner compute node. Also, in the situation where the owner compute node is an exited compute node, each replicating compute node would seek to republish the associated replica KV pairs associated with the owner compute node. A recipient compute node receiving duplicative republishing requests will act on just one of the duplicative republishing requests.

### Delete Operation

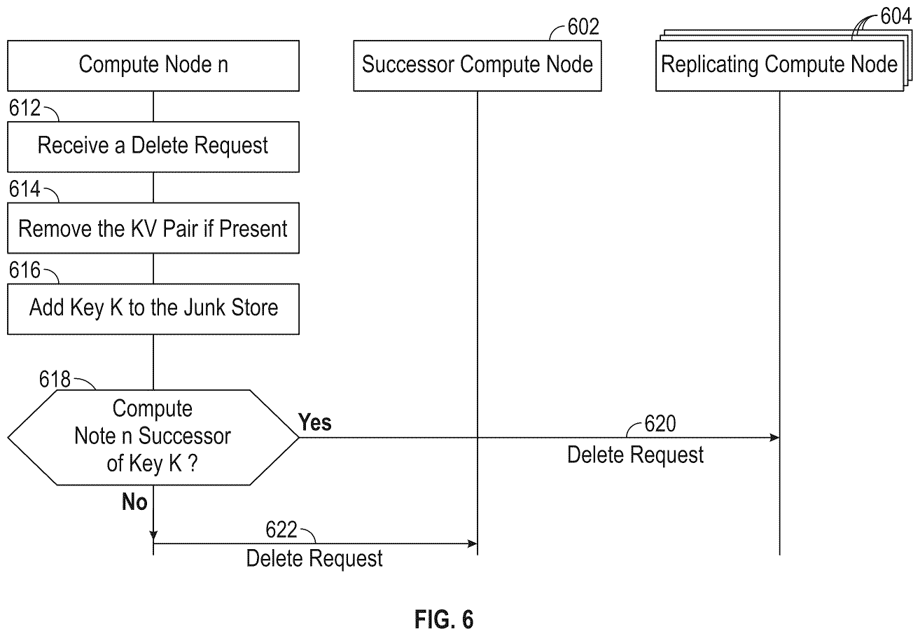

FIG. 6 shows a delete process. Although FIG. 6 shows a sequence of tasks, note that in other examples, the tasks may be performed in a different order, some of the tasks may be omitted, and other tasks may be added

Compute node n receives (at 612) a delete request to delete a KV pair containing key k. The delete request may be received from a requester. In response to the delete request, compute node n calls a Delete routine, which removes (at 614) the KV pair containing key k if present in compute node n. For example, the KV pair containing key k may be present in the local KV store 104 or the replica KV store 106 of compute node n. Note that it is also possible that compute node n does not store the KV pair containing key k, in which case task 614 is not performed.

The Delete routine adds (at 616) key k to the junk store 110 in compute node n. Even if compute node n does not store the KV pair containing key k, compute node n nevertheless adds key k to the junk store 110 to provide a record of a deletion of key k. The junk store 110 acts as a cache of recently deleted keys, and the junk store 110 contains timestamps indicating times of deletions of respective keys.

The Delete routine determines (at 618) whether compute node n is the successor of key k (i.e., key k is assigned to compute node n). If so, the Delete routine forwards (at 620) the delete request to each replicating compute node 604 for compute node n to delete a replica of the KV pair containing key k.

However, if compute node n is not the successor of key k, as determined (at 618), after placing deleted key k in the junk store 110, compute node n forwards (at 622) the delete request of key k to a successor compute node 602 of key k. The successor compute node 602 handles the delete request in a manner similar to the handling performed by compute node n.

As discussed further above, the maintenance module 122 in a compute node that has deleted a KV pair sends, in a maintenance interval, a Key Notify message (which is a broadcast message), which identifies a set of keys (and time of deletion of each key) added to the junk store 110 of the compute node. The Key Notify message causes the other compute nodes in the distributed system 100 to add deleted key k to their respective junk stores 110.

A key is kept in the junk store 110 for the specified junk store retention period, after which the key is removed from the junk store 110. The maintenance module 122 in compute node n can call a Clean Junk Store routine in a maintenance interval. The Clean Junk Store routine removes, from the junk store 110, any keys that have been deleted for more than specified junk store retention period.

### Further Examples

In some examples, the distributed system 100 may be part of an object storage system. For example, the compute nodes 102-1 to 102-N of the distributed system 100 may include command and control nodes of the object storage system. The command and control nodes can maintain metadata for data stored in the object storage system. In such examples, the compute nodes 102-1 to 102-N can include containers that are selectively activated based on one or more criteria. A criterion can include a cost criterion, such as cost per compute cycle. The cost associated with operating a container may vary at different times. In some examples, the number of active containers can be reduced when the cost is higher, such as by deactivating one or more containers. Based on replicating metadata of an owner container at other replicating containers (e.g., the R replicating compute nodes as discussed further above), the metadata may still be available to clients even if the owner container or any of the replicating containers is deactivated. An owner container is an example of an owner computer node discussed further above.

Additionally, when an owner container is deactivated, a replicating container can republish replica metadata associated with the owner container so that the metadata associated with the owner container can be placed in one or more other containers.

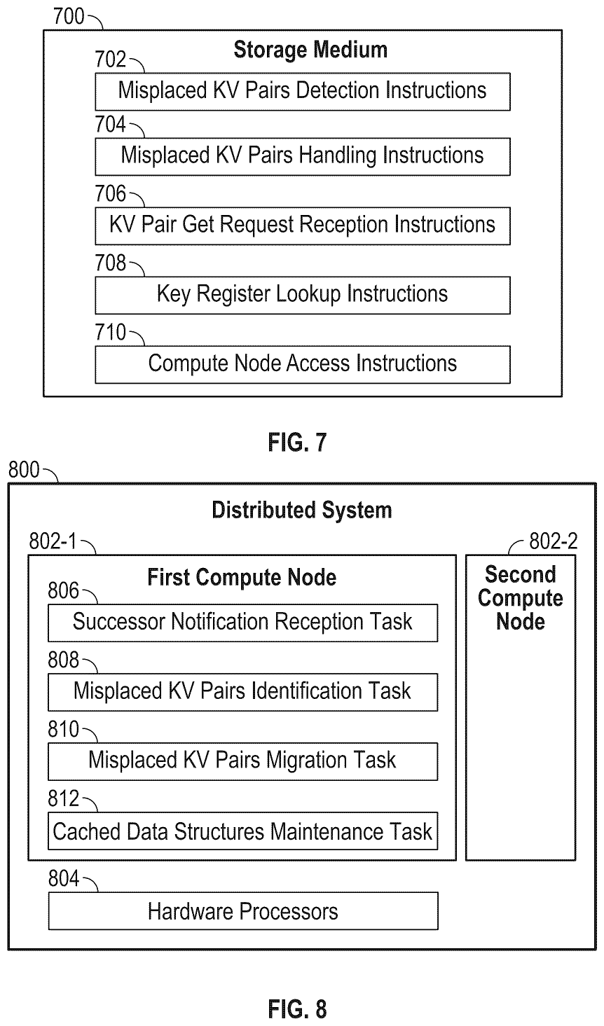

FIG. 7 is a block diagram of a non-transitory machine-readable or computer-readable storage medium 700 storing machine-readable instructions executable in a distributed system (e.g., 100 in FIG. 1) to perform various tasks.

The machine-readable instructions include misplaced KV pairs detection instructions 702 to detect misplaced KV pairs in a first compute node of a plurality of compute nodes in the distributed system. For example, the first compute node may be (1) a successor compute node of a new compute node that has joined the distributed system, or (2) a replicating compute node that is no longer part of the collection of replicating compute nodes for an owner compute node due to the new compute node joining.

The machine-readable instructions include misplaced KV pairs handling instructions 704 to, in a maintenance interval, initiate handling of the misplaced KV pairs at the first compute node. Maintenance tasks in maintenance intervals of the distributed system are part of a lazy evaluation process that performs gradual updates of a distributed system in response to transient conditions due to compute nodes joining and exiting the distributed system. The handling of the misplaced KV pairs can include (1) migrating the misplaced KV pairs from the first compute node to a predecessor compute node (e.g., the joining compute node), or (2) removing the misplaced KV pairs from the first compute node (e.g., because the first compute node is no longer part of the collection of replicating compute nodes).

The machine-readable instructions include KV pair get request reception instructions 706 to receive, at a second compute node of the distributed system, a request for a first key. The second compute node may not be the owner of the requested first key.

The machine-readable instructions include key register lookup instructions 708 to, based on determining that a data store of the second compute node does not contain the first key, access, by the second compute node, a key register to identify a compute node that contains the first key, where the key register maps keys to respective compute nodes. The data store of the second compute node may be a local KV store or a replica KV store.

The machine-readable instructions include compute node access instructions 710 to access, by the second compute node, the identified compute node to obtain a value for the first key.

In some examples, the first compute node is part of a collection of replication compute nodes for an owner compute node, where each replication compute node of the collection of replication compute nodes stories replica KV pairs for the owner compute node. The handling of the misplaced KV pairs at the first compute node includes removing the misplaced KV pairs from a replica KV store at the first compute node.

In some examples, the first compute node detects (such as by calling the Trim Replications routine in a maintenance interval discussed above) that the owner compute node is unreachable or is no longer storing a set of KV pairs. Based on detecting that the owner compute node is unreachable or no longer storing the set of KV pairs, the first compute node republishes associated replica KV pairs to the distributed system, and removes the associated replica KV pairs from a replica KV store of the first compute node. The associated replica KV pairs are replicas of respective KV pairs in the owner compute node.

In some examples, the first compute node determines (such as by calling the Maintain Replications routine in a maintenance interval discussed above) whether the first compute node is in a successor list of the owner compute node. Based on determining that the first compute node is not in the successor list of the owner compute node, the first compute node republishes replica KV pairs associated with the owner compute node to the distributed system, and removes the associated replica KV pairs from a replica KV store of the first compute node.

In some examples, the misplaced KV pairs at the first compute node results from a new compute node joining the distributed system after the owner compute node and the collection of replication compute nodes.

In some examples, for any given compute node of the distributed system, replicas of KV pairs owned by the given compute node are replicated to R compute nodes, where R≥2 and is based on a number of bits (m) used to form identifiers of keys and compute nodes. As m increases, the number (R) of replicating compute nodes can also increase.

In some examples, the owner compute node determines (such as by calling the Maintain Replicators routine in a maintenance interval discussed above) a quantity of the replicating compute nodes associated with the owner compute node. Based on determining that the quantity of the replicating compute nodes is less than R, the owner compute node adds at least another replicating compute node for the owner compute node.

In some examples, the distributed system arranges the plurality of compute nodes as successors or predecessors of one another based on node identifiers of the compute nodes of the plurality of compute nodes. The second compute node is a new compute node that joined the distributed system after the first compute node and a third compute node that is a predecessor of the first compute node. The second compute node joined the distributed system as a successor of the third compute node and a predecessor of the first compute node.

In some examples, the detecting of the misplaced KV pairs is based on determining, according to key identifiers of keys of the misplaced KV pairs and node identifiers of the first and second compute nodes, that a subset of KV pairs locally stored at the first compute node are owned by the second compute node as a result of the joining of the second compute node to the distributed system.

In some examples, a first subset of the misplaced KV pairs is migrated in the maintenance interval, the first subset including a quantity of KV pairs capped by a size parameter (e.g., 130 in FIG. 1). The machine-readable instructions can migrate a second subset of the misplaced KV pairs from the first compute node to the second compute node in a subsequent maintenance interval.

In some examples, the machine-readable instructions can update the key register based on a broadcast message sent, in a maintenance interval, by a third compute node of the plurality of compute nodes.

In some examples, the broadcast message identifies one or more of: keys assigned to the third compute node and locally stored at the third compute node, keys of replica KV pairs stored at the third compute node for another compute node, or keys in a junk store of the third compute node, the keys in the junk store referring to deleted KV pairs.

In some examples, the first compute node receives a delete request to delete a KV pair, and adds a first key of the deleted KV pair to a junk store that contains a cached list of recently deleted keys. The first compute node forwards, to a third compute node, the delete request to cause deletion of the KV pair at the third compute node.

In some examples, the third compute node is a replicating compute node for the first compute node.

In some examples, the third compute node is a successor compute node of the first compute node. The first compute node can forward the delete request to the third compute node based on a determination at the first compute node that the first compute node is not an owner of the KV pair to be deleted.

In some examples, the plurality of compute nodes includes containers, and the machine-readable instructions can deactivate a first container of the containers based on a criterion (e.g., a cost criterion), and access a KV pair previously stored at the deactivated first container using a replica KV pair from another container.

FIG. 8 is a block diagram of a distributed system 800, such as the distributed system 100 of FIG. 1. The distributed system 800 includes a plurality of compute nodes 802-1 and 802-2, and hardware processors 804 associated with the plurality of compute nodes 802. If the compute nodes 802-1 and 802-2 are physical computers, then the hardware processors 804 are part of the physical computers. If the compute nodes 802-1 and 802-2 are virtual compute nodes, then the hardware processors 804 execute the virtual compute nodes.

A hardware processor can include a microprocessor, a core of a multi-core microprocessor, a microcontroller, a programmable integrated circuit, a programmable gate array, or another hardware processing circuit.

The first compute node 802-1 can perform various tasks. The tasks of the first compute node 802-1 include a successor notification reception task 806 to receive, from the second compute node 802-2 that has joined the distributed system 800 after the first compute node 802-1, a notification that the second compute node 802-2 has assigned the first compute node 802-1 as a successor compute node of the second compute node 802-2. The successor notification may include a Node Notify message as discussed above.

The tasks of the first compute node 802-1 include a misplaced KV pairs identification task 808 to identify misplaced KV pairs stored at the first compute node 802-1 based on the joining of the second compute node 802-2 to the distributed system 800. This can be determined based on calling the Trim Store routine discussed further above, for example.

The tasks of the first compute node 802-1 include a misplaced KV pairs migration task 810 to, in a maintenance interval, migrate the misplaced KV pairs from the first compute node 802-1 to the second compute node 802-2, where a quantity of the misplaced KV pairs migrated in the maintenance interval is capped by a size parameter (e.g., 130 in FIG. 1).

The tasks of the first compute node 802-1 include a cached data structures maintenance task 812 to maintain, at the first compute node 802-1, a key register that maps keys to respective compute nodes of the distributed system 800, and a junk store that lists deleted keys.

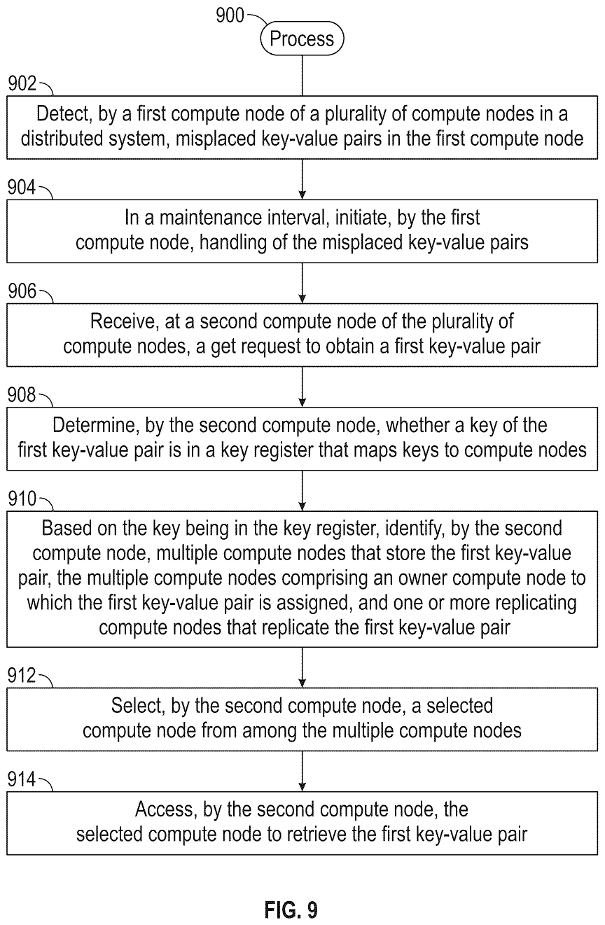

FIG. 9 is a flow diagram of a process 900 according to some examples, which may be performed in a distributed system (e.g., 100 in FIG. 1 or 800 in FIG. 8).

The process 900 includes detecting (at 902), by a first compute node of a plurality of compute nodes in the distributed system, misplaced KV pairs in the first compute node. The misplaced KV pairs may be caused by joinder of a compute node into the distributed system.

The process 900 includes initiating (at 904), by the first compute node in a maintenance interval, handling of the misplaced KV pairs. The maintenance interval may be periodically triggered or triggered in response to another event.

The process 900 includes receiving (at 906), at a second compute node of the plurality of compute nodes, a get request to obtain a first KV pair. An example of the get request is the Get request 202 of FIG. 2.

The process 900 includes determining (at 908), by the second compute node, whether a key of the first KV pair is in a key register that maps keys to compute nodes.

Based on the key being in the key register, the process 900 includes identifying (at 910), by the second compute node, multiple compute nodes that store the first KV pair. The multiple compute nodes include an owner compute node to which the first KV pair is assigned, and one or more replicating compute nodes that replicate the first KV pair.

The process 900 includes selecting (at 912), by the second compute node, a selected compute node from among the multiple compute nodes. The selection can include a random selection or a selection according to another criterion.

The process 900 includes accessing (at 914), by the second compute node, the selected compute node to retrieve the first KV pair.

Although various routine names are discussed in the foregoing examples, in other examples, the routines can have different names, functionalities of multiple routines can be combined into one routine, or functionalities of one routine may be separated into multiple routines.

A “processing resource” includes one or more hardware processors. Examples of a persistent memory device can include a flash memory device, an erasable and programmable read-only memory (EPROM), an electrically erasable and programmable read-only memory (EEPROM), or another type of nonvolatile memory device.

A storage medium (e.g., 700 in FIG. 7) can include any or some combination of the following: a semiconductor memory device such as a dynamic or static random access memory (a DRAM or SRAM), an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A non-transitory machine-readable storage medium comprising instructions executable in a distributed system comprising a plurality of compute nodes to:
detect misplaced key-value pairs in a first compute node of the plurality of compute nodes, the misplaced key-value pairs resulting from a joinder of an additional compute node to the distributed system;
in a maintenance interval:
access, at the first compute node, a size parameter specifying a cap on a quantity of key-value pairs allowed to be transferred per maintenance interval, and
initiate handling of the misplaced key-value pairs at the first compute node, the handling of the misplaced key-value pairs at the first compute node comprising migrating a subset of the misplaced key-value pairs including a quantity of misplaced key-value pairs according to the size parameter from the first compute node to the additional compute node in the maintenance interval;
receive a request for a first key at a second compute node of the plurality of compute nodes;
based on determining that a data store of the second compute node does not contain the first key, access, by the second compute node, a key register to identify a compute node that contains the first key, wherein the key register maps keys to respective compute nodes; and
access, by the second compute node, the identified compute node to obtain a value for the first key.

2. The non-transitory machine-readable storage medium of claim 1, wherein the first compute node is part of a collection of replication compute nodes for an owner compute node, each replication compute node of the collection of replication compute nodes storing replica key-value pairs for the owner compute node, and
wherein the handling of the misplaced key-value pairs at the first compute node comprises removing the misplaced key-value pairs from a replica key-value store at the first compute node.

3. The non-transitory machine-readable storage medium of claim 2, wherein the instructions are executable in the distributed system to:
detect, by the first compute node, that the owner compute node is unreachable or is no longer storing a set of key-value pairs; and
based on detecting that the owner compute node is unreachable or no longer storing the set of key-value pairs, republish, by the first compute node, replica key-value pairs associated with the owner compute node to the distributed system, and remove the associated replica key-value pairs from the replica key-value store of the first compute node.

4. The non-transitory machine-readable storage medium of claim 2, wherein the instructions are executable in the distributed system to:
determine, by the first compute node, whether the first compute node is in a successor list of the owner compute node; and
based on determining that the first compute node is not in the successor list of the owner compute node, republish, by the first compute node, replica key-value pairs associated with the owner compute node to the distributed system, and remove the associated replica key-value pairs from the replica key-value store of the first compute node.

5. The non-transitory machine-readable storage medium of claim 2, wherein the additional compute node joined the distributed system after the owner compute node and the collection of replication compute nodes.

6. The non-transitory machine-readable storage medium of claim 2, wherein for any given compute node of the distributed system, replicas of key-value pairs owned by the given compute node are replicated to R compute nodes, where R≥2 and is based on a number of bits used to form identifiers of keys and compute nodes.

7. The non-transitory machine-readable storage medium of claim 6, wherein the instructions are executable in the distributed system to:
determine, by the owner compute node, a quantity of the replication compute nodes for the owner compute node; and
based on determining that the quantity of the replication compute nodes is less than R, add at least another replication compute node for the owner compute node.

8. The non-transitory machine-readable storage medium of claim 1, wherein the distributed system arranges the plurality of compute nodes as successors or predecessors of one another based on node identifiers of the compute nodes of the plurality of compute nodes,
wherein the additional compute node joined the distributed system as a predecessor of the first compute node.

9. The non-transitory machine-readable storage medium of claim 1, wherein the maintenance interval is a first maintenance interval, the subset is a first subset, and the handling of the misplaced key-value pairs at the first compute node further comprises:
in a second maintenance interval, migrate a second subset of the misplaced key-value pairs including a quantity of misplaced key-value pairs according to the size parameter from the first compute node to the additional compute node.

10. The non-transitory machine-readable storage medium of claim 1, wherein the detecting of the misplaced key-value pairs is based on determining, according to key identifiers of keys of the misplaced key-value pairs and node identifiers of the first and additional compute nodes, that a collection of key-value pairs locally stored at the first compute node are owned by the additional compute node as a result of the joinder of the additional compute node to the distributed system.

11. The non-transitory machine-readable storage medium of claim 9, wherein the instructions are executable in the distributed system to:
receive, at the second compute node, a write request to write a given key-value pair;
access, by the second compute node, a junk store that lists keys that have been deleted from the distributed system; and
based on detecting that the given key-value pair is listed by the junk store, decline to write the given key-value pair in response to the write request.

12. The non-transitory machine-readable storage medium of claim 1, wherein the instructions are executable in the distributed system to:
update the key register based on a broadcast message sent, in a maintenance interval, by a third compute node of the plurality of compute nodes.

13. The non-transitory machine-readable storage medium of claim 12, wherein the broadcast message identifies one or more of:
keys assigned to the third compute node and locally stored at the third compute node,
keys of replica key-value pairs stored at the third compute node for another compute node, or
keys in a junk store of the third compute node, the keys in the junk store referring to deleted key-value pairs.

14. The non-transitory machine-readable storage medium of claim 1, wherein the instructions are executable in the distributed system to:
receive, at the first compute node, a delete request to delete a key-value pair;
add a first key of the deleted key-value pair to a junk store that contains a cached list of recently deleted keys; and
forward, from the first compute node to a third compute node, the delete request to cause deletion of the key-value pair at the third compute node.

15. The non-transitory machine-readable storage medium of claim 14, wherein the third compute node is a replicating compute node for the first compute node.

16. The non-transitory machine-readable storage medium of claim 14, wherein the third compute node is a successor compute node of the first compute node, and wherein the instructions are executable in the distributed system to:
forward the delete request from the first compute node to the third compute node based on a determination at the first compute node that the first compute node is not an owner of the key-value pair to be deleted.

17. The non-transitory machine-readable storage medium of claim 1, wherein the plurality of compute nodes comprises containers, and the instructions upon execution cause the distributed system to:
deactivate a first container of the containers based on a criterion; and
access a key-value pair previously stored at the deactivated first container using a replica key-value pair from another container.

18. A distributed system comprising:
a plurality of compute nodes; and
hardware processors associated with the plurality of compute nodes, wherein a first compute node of the plurality of compute nodes is to:
receive, from a second compute node that has joined the distributed system after the first compute node, a notification that the second compute node has assigned the first compute node as a successor compute node of the second compute node;
identify misplaced key-value pairs stored at the first compute node based on the joining of the second compute node to the distributed system;
in a maintenance interval:
access, at the first compute node, a size parameter specifying a cap on a quantity of key-value pairs allowed to be transferred per maintenance interval, and
migrate a subset of the misplaced key-value pairs including a quantity of misplaced key-value pairs according to the size parameter from the first compute node to the second compute node,
maintain, at the first compute node, a key register that maps keys to respective compute nodes of the distributed system, and a junk store that lists deleted keys.

19. The distributed system of claim 18, wherein the first compute node comprises a replica key-value store that stores replica key-value pairs for another compute node of the distributed system.

20. A method comprising:
detecting, by a first compute node of a plurality of compute nodes in a distributed system, misplaced key-value pairs in the first compute node, the misplaced key-value pairs resulting from a joinder of an additional compute node to the distributed system;
in a maintenance interval:
accessing, at the first compute node, a size parameter specifying a cap on a quantity of key-value pairs allowed to be transferred per maintenance interval, and
initiating, by the first compute node, handling of the misplaced key-value pairs, the handling of the misplaced key-value pairs at the first compute node comprising migrating a subset of the misplaced key-value pairs including a quantity of misplaced key-value pairs according to the size parameter from the first compute node to the additional compute node in the maintenance interval;
receiving, at a second compute node of the plurality of compute nodes, a get request to obtain a first key-value pair;
determining, by the second compute node, whether a key of the first key-value pair is in a key register that maps keys to compute nodes;
based on the key being in the key register, identifying, by the second compute node, multiple compute nodes that store the first key-value pair, the multiple compute nodes comprising an owner compute node to which the first key-value pair is assigned, and one or more replicating compute nodes that replicate the first key-value pair;
selecting, by the second compute node, a selected compute node from among the multiple compute nodes; and
accessing, by the second compute node, the selected compute node to retrieve the first key-value pair.
